(19) United States
(12) Patent Application Publication
(10) Pub. No.: US 2015/0040308 A1
(43) Pub. Date: Feb. 12, 2015

(54) Sauna Device Having Split Panels

(71) Applicant: Sang Won LEE, Yorba Linda, CA (US)

(72) Inventor: Sang Won LEE, Yorba Linda, CA (US)

(21) Appl. No.: 13/960,661

(22) Filed: Aug. 6, 2013

(51) Int. Cl. A61H 33/06

(52) U.S. Cl. CPC A61H 33/066; A61H 2201/0107
USPC 4/524

(57) ABSTRACT

A sauna device having split panels is provided. Each of panel portion has two or more panels, and neighboring panels are assembled with first or second internal mechanical fasteners and first, second, or first and second external mechanical fasteners. The first and second internal mechanical fasteners are installed between edges of the neighboring panels. The first external mechanical fasteners are installed across border between inner surfaces of the neighboring panels. The second external mechanical fasteners are installed across border between outer surfaces of the neighboring panels.

### BACKGROUND OF THE INVENTION

The present invention relates to a sauna device. More particularly, this invention relates to a sauna device, which can be built conveniently.

Accordingly, a need for a sauna device has been present for a long time considering the expansive demands in the everyday life. This invention is directed to solve these problems and satisfy the long-felt need.

### SUMMARY OF THE INVENTION

The present invention contrives to solve the disadvantages of the prior art.

An aspect of the invention provides a sauna device comprising a bottom panel portion, a rear panel portion, a left side panel portion, a right side panel portion, a front panel portion, a top panel portion, and a ceiling panel portion.

The bottom panel portion has two or more bottom panels, and neighboring bottom panels are assembled with a plurality of first internal mechanical fasteners, a plurality of first external mechanical fasteners, and a plurality of second external mechanical fasteners.

The rear panel portion has two or more rear panels, and neighboring rear panels are assembled with a plurality of first internal mechanical fasteners, a plurality of first external mechanical fasteners, and a plurality of second external mechanical fasteners.

The left side panel has two or more left side panels, and neighboring left side panels are assembled with a plurality of first internal mechanical fasteners, a plurality of first external mechanical fasteners, and a plurality of second external mechanical fasteners.

The right side panel has two or more right side panels, and neighboring right side panels are assembled with a plurality of first internal mechanical fasteners, a plurality of first external mechanical fasteners, and a plurality of second external mechanical fasteners.

The front panel portion has a left front panel and a right front panel, and the left front panel and the right front panel are assembled with a plurality of second internal mechanical fasteners, a plurality of first external mechanical fasteners, and a plurality of second external mechanical fasteners.

The ceiling panel portion has two or more ceiling panels, wherein neighboring ceiling panels are assembled with a plurality of first internal mechanical fasteners and a plurality of second external mechanical fasteners.

The internal mechanical fasteners are installed between edges of the neighboring panels.

The first external mechanical fasteners are installed across border between inner surfaces of the neighboring panels.

The second external mechanical fasteners are installed across border between outer surfaces of the neighboring panels.

Each of the first internal mechanical fasteners may comprise a dowel and two holes provided through the edge of each of the right and left panels.

Each of the second internal mechanical fasteners may comprise an insert nut and a bolt.

Each of the first external mechanical fasteners may comprise two beams and two or more screws, and each of the two beams is installed along an edge on the outer surfaces of the right and left panels, and the each of the two or more screws is fastened through the two beams.

Each of the second external mechanical fasteners may comprise a buckle.

The sauna device may further comprise a high bench heater provided at a corner defined by the bottom panel portion, the rear panel portion, and the left and right side panels.

The sauna device may further comprise a low bench heater provided the high bench heater.

One of the left and right panels of the front panel portion may comprise a door.

Each of the first internal mechanical fasteners may comprise a corner bracket, wherein the corner bracket is configured to align the neighboring panels.

The corner bracket may comprise a male portion having two or more fastening holes and a protrusion, and a female portion having two or more fastening holes and a locking hole. The male portion is attached to a first edge through the two or more fastening holes and the female portion is attached to a second edge through the two or more fastening holes, and the male portion and the female portion are configured to be locked so as to align the neighboring panels.

Each of the first external mechanical fasteners may comprise a buckle.

Each of the second external mechanical fasteners may comprise two beams and two or more screws, and each of the two beams is installed along an edge on the outer surfaces of the right and left panels, and the each of the two or more screws is fastened through the two beams.

The advantages of the present invention are: (1) the sauna device can be assembled easily; and (2) the sauna device is free of mismatch or distorsion.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective front view of a sauna device assembled according to an embodiment of the invention;

FIG. 2 is a perspective front view of a sauna device assembled according to an embodiment of the invention;

FIG. 3 is an inside view of a rear, bottom, side panel portion assembled according to an embodiment of the invention;

FIG. 4 is an outside view of a rear, bottom, side panel portion assembled according to an embodiment of the invention;

FIG. 5 is an outside view of a front panel portion portion assembled according to an embodiment of the invention;

FIG. 6 is an outside view of a top panel portion portion assembled according to an embodiment of the invention;

FIG. 7 is a perspective view of a dowel and a buckle according to an embodiment of the invention;

FIG. 8 is a top view of a dowel installed between two panels;

FIG. 9 is a top view of an external mechanical fastener using beams and screws according to an embodiment of the invention;

FIG. 10 is a front view of FIG. 9 without screws;

FIG. 11 is a side view of an insert nut and a bolt according to an embodiment of the invention; and

FIG. 12 is a perspective view of a corner bracket according to an embodiment of the invention.

### DETAILED DESCRIPTION EMBODIMENTS OF THE INVENTION

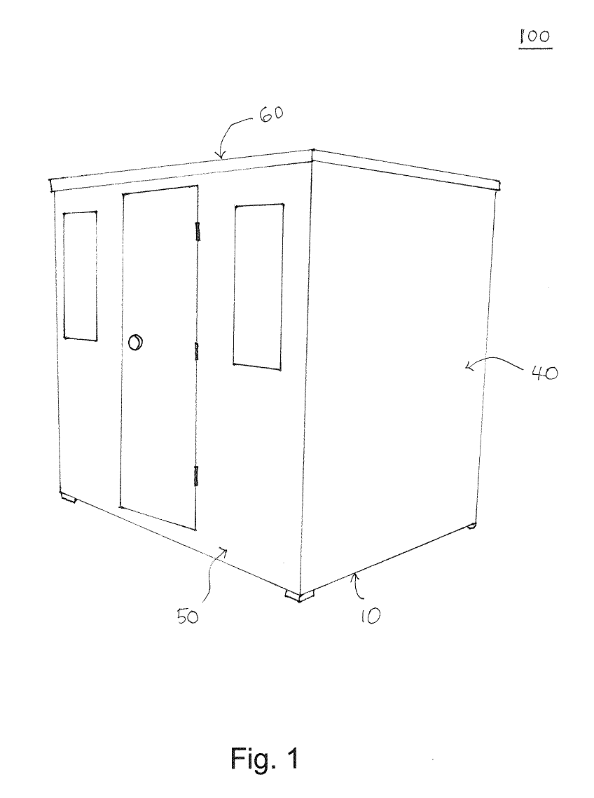

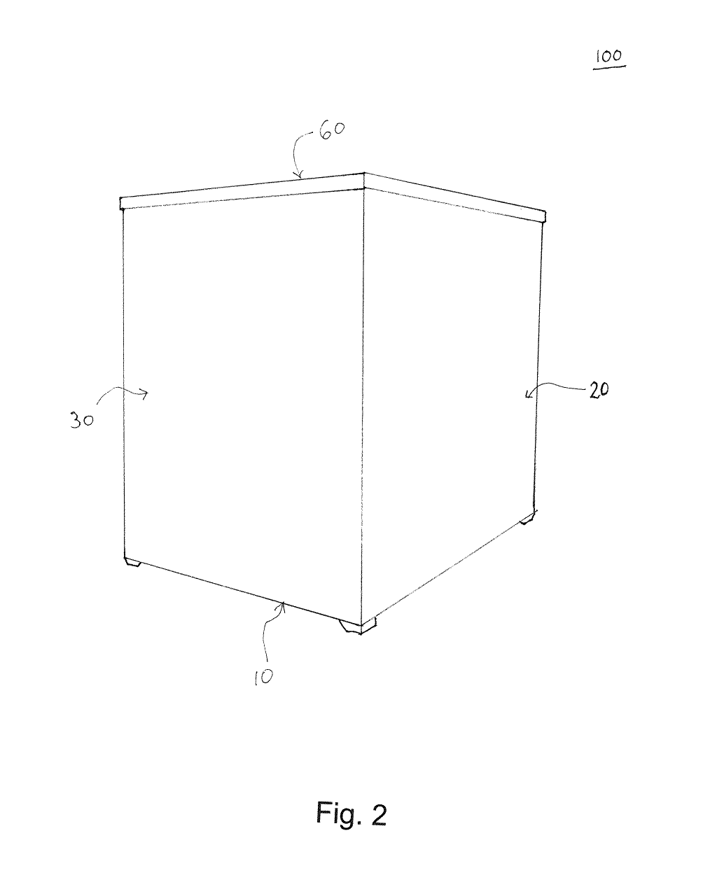

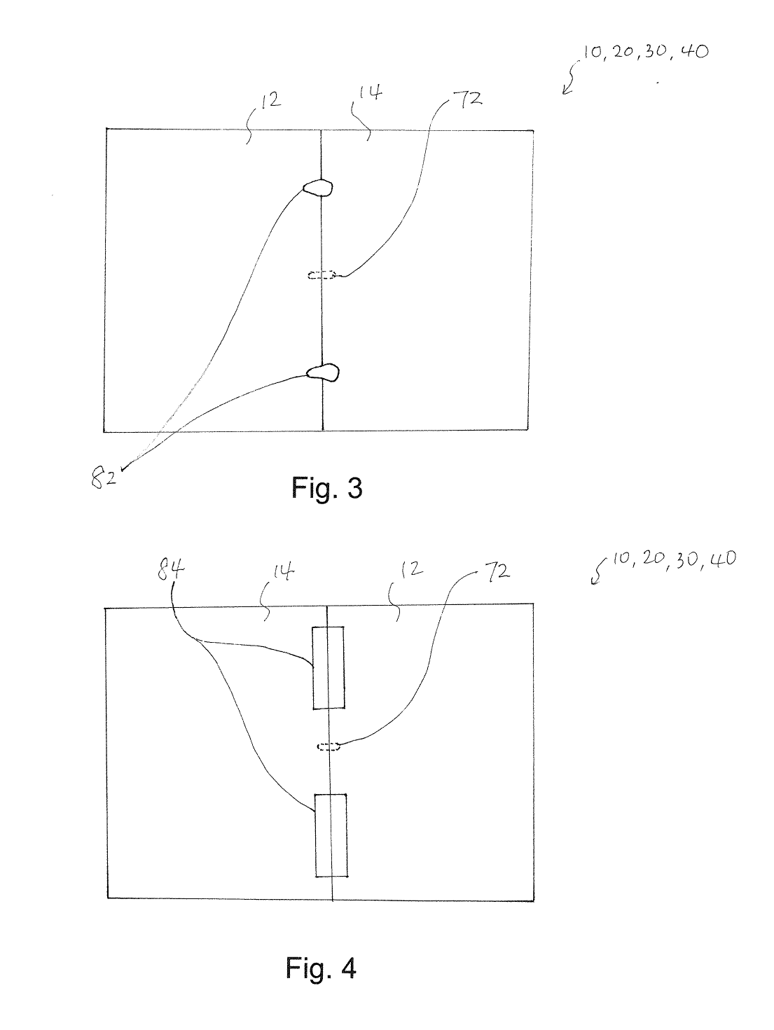

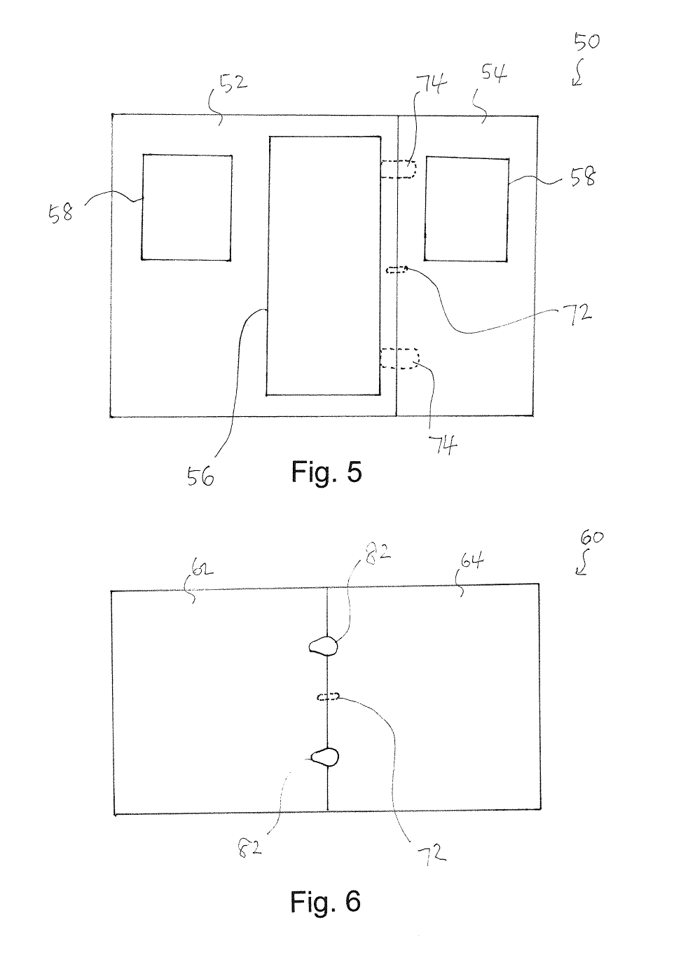

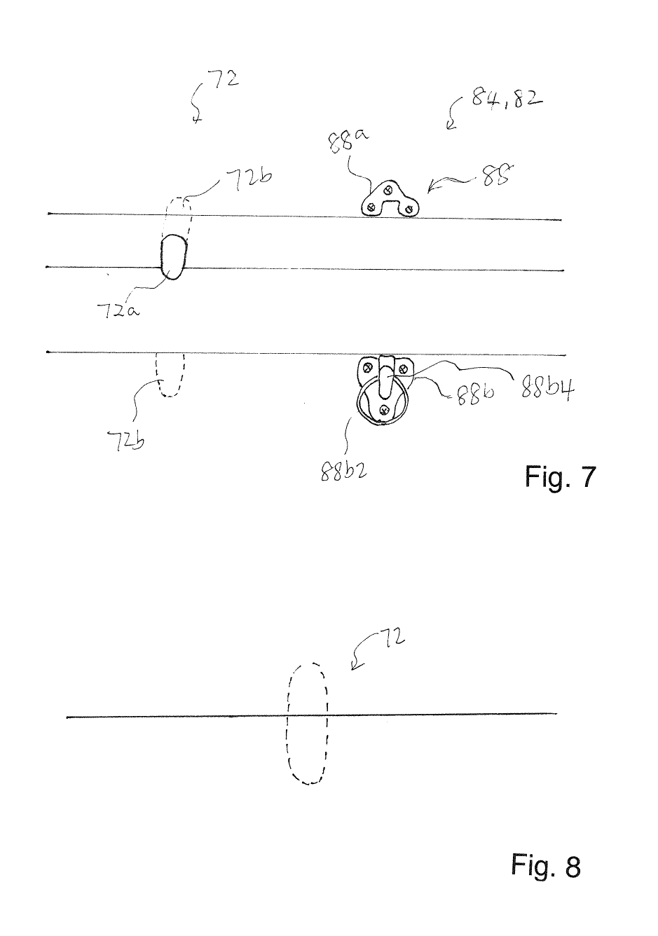

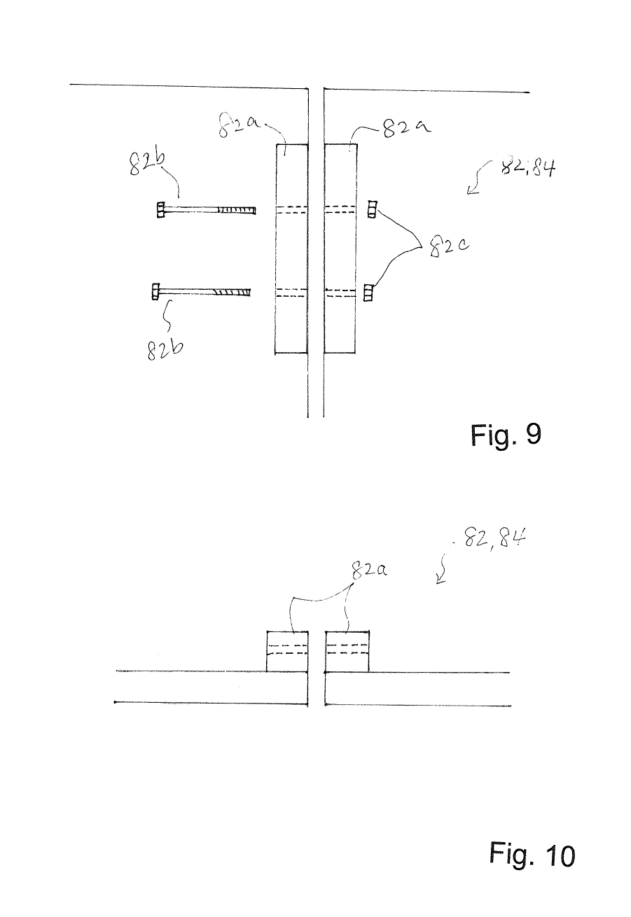

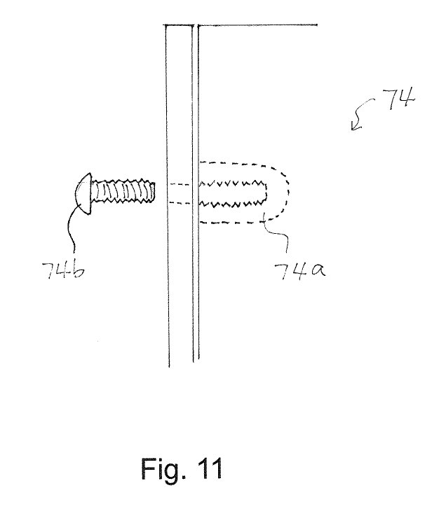

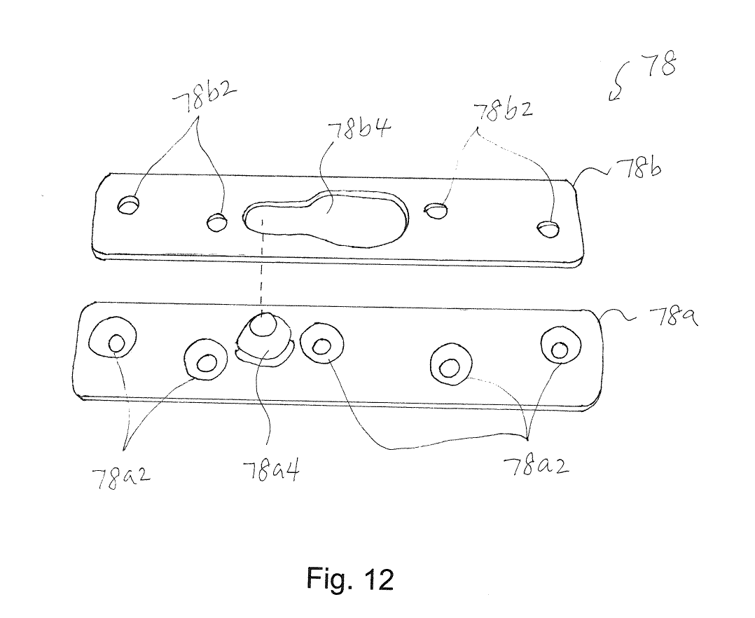

FIGS. 1 and 2 show a sauna device assembled. FIG. 3 shows one of inside or outside view of a rear, bottom, or side panel portion. FIG. 4 shows another one of inside or outside view of a rear, bottom, or side panel portion. FIG. 5 shows an outside view of a front panel portion assembled. FIG. 6 shows an outside view of a top panel portion assembled. FIGS. 7 and 8 show a dowel and a buckle. FIGS. 9 and 10 show an external mechanical fastener using beams and screws. FIG. 11 is a side view of an insert nut and a bolt. FIG. 12 shows a corner bracket.

An aspect of the invention provides a sauna device 100 comprising a bottom panel portion 10, a rear panel portion 20, a left side panel portion 30, a right side panel portion 40, a front panel portion 50, and a ceiling panel portion 60.

The embodiment illustrated in FIGS. 3 and 4 show one of inside or outside view of a rear, bottom, or side panel portions, 10, 20, 30, 40, which includes two panels 12, 14. The bottom panel portion 10 has two or more bottom panels 12, 14, and neighboring bottom panels 12, 14 are assembled with a plurality of first internal mechanical fasteners 72, a plurality of first external mechanical fasteners 82, and a plurality of second external mechanical fasteners 84 as shown in FIGS. 3 and 4.

In the illustrated embodiments, as discussed in the above, the bottom panel portion 10 comprises just two, left and right, bottom panels 12, 14. The same can be applied to one of the other panel portions. Of course, there may be more than two panels horizontally as well as vertically.

The rear panel portion 20 has two or more rear panels, and neighboring rear panels are assembled with a plurality of first internal mechanical fasteners, a plurality of first external mechanical fasteners, and a plurality of second external mechanical fasteners as shown in FIGS. 3 and 4.

The left side panel portion 30 has two or more left side panels, and neighboring left side panels are assembled with a plurality of first internal mechanical fasteners, a plurality of first external mechanical fasteners, and a plurality of second external mechanical fasteners as shown in FIGS. 3 and 4.

The right side panel portion 40 has two or more right side panels, and neighboring right side panels are assembled with a plurality of first internal mechanical fasteners, a plurality of first external mechanical fasteners, and a plurality of second external mechanical fasteners as shown in FIGS. 3 and 4.

FIG. 5 shows an outside view of a front panel portion portion assembled. The front panel portion 50 has a left front panel 52 and a right front panel 54, and the left front panel 52 and the right front panel 54 are assembled with a plurality of second internal mechanical fasteners 74, a plurality of first external mechanical fasteners (not shown), and a plurality of second external mechanical fasteners (not shown).

The ceiling panel portion 60 has two or more ceiling panels 62, 64, wherein neighboring ceiling panels 62, 64 are assembled with a plurality of first internal mechanical fasteners 72 and a plurality of one or second external mechanical fasteners 82, 84 as shown in FIG. 6.

The internal mechanical fasteners 72, 74 are installed between edges of the neighboring panels as shown FIGS. 5 and 6.

The main function of the first or second internal mechanical fasteners 72, 74 is aligning the neighboring panels. Therefore, the internal mechanical fasteners 72, 74 are installed between the edges of the neighboring panels, usually not obtrusively.

The first external mechanical fasteners 82 are installed across border between inner surfaces of the neighboring panels.

The second external mechanical fasteners 84 are installed across border between outer surfaces of the neighboring panels.

Each of the first internal mechanical fasteners 72 may comprise a dowel 72a and two holes 72b provided through the edge of each of the right and left panels as shown in FIGS. 7 and 8.

Each of the second internal mechanical fasteners 74 may comprise an insert nut 74a and a bolt 74b as shown in FIG. 11.

Each of the first external mechanical fasteners 82 may comprise two beams 82a and two or more screws 82b, and each of the two beams 82a is installed along an edge on the outer surfaces of the right and left panels, and the each of the two or more screws 82b is fastened through the two beams 82a. The two or more screws 82b may be fastened with corresponding nuts 82c as shown in FIG. 9.

Each of the second external mechanical fasteners 84 may comprise a buckle as shown in FIG. 7.

The sauna device 100 may further comprise a high bench heater (not shown) provided at a corner defined by the bottom panel portion 10, the rear panel portion 20, and the left and right side panels 30, 40.

The sauna device 100 may further comprise a low bench heater (not shown) provided the high bench heater.

One of the left and right panels 52, 54 of the front panel portion 50 may comprise a door 56. Also, they may have one or more windows 58 as shown in FIG. 5.

Each of the first internal mechanical fasteners 72 may comprise a corner bracket 78, and the corner bracket 78 is configured to align the neighboring panels just like the dowels.

The corner bracket 78 may comprise a male portion 78a having two or more fastening holes 78a2 and a protrusion 78a4, and a female portion 78b having two or more fastening holes 78b2 and a locking hole 78b4. The male portion 78a is attached to a first edge of corresponding panel through the two or more fastening holes 78a2 and the female portion 78b is attached to a second edge of corresponding panel through the two or more fastening holes 78b2, and the male portion 78a and the female portion 78b are configured to be locked so as to align the neighboring panels as shown in FIG. 12.

Alternatively, each of the first external mechanical fasteners 82 may comprise a buckle 88 as shown in FIG. 7.

The buckle 88 may comprises a latch portion 88a and a buckle portion 88b, which are attached at corresponding end portions of the inner or outer surface of the neighboring panels respectively. The latch portion 88a is a L-shaped, and the buckle portion 88b has a circular or rectangular ring 88b2 and a locking handle 88b4.

Also, alternatively, each of the second external mechanical fasteners 84 may comprise two beams and two or more screws, and each of the two beams is installed along an edge on the outer surfaces of the right and left panels, and the each of the two or more screws is fastened through the two beams.

Of course, the mechanical fasteners are not limited to the above examples. If holding and fixing the neighboring panels, any type of fasteners may be adopted.

In certain embodiments, one or more panel portions, especially the side panel portions, may be provided by a single panel.

Even though mechanical fasteners are used mainly for assembling the panel portion with the two or more panels, the sauna device 100 according to the invention also needs other mechanical fasteners for assembling the panel portions, neighboring portions of which meeting usually perpendicularly. Since they are well known in the community of the art, such mechanical fasteners were not shown.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A sauna device having split panels comprising:
a bottom panel portion having two or more bottom panels, wherein neighboring bottom panels are assembled with a plurality of first internal mechanical fasteners, a plurality of first external mechanical fasteners, and a plurality of second external mechanical fasteners;
a rear panel portion having two or more rear panels, wherein neighboring rear panels are assembled with a plurality of first internal mechanical fasteners, a plurality of first external mechanical fasteners, and a plurality of second external mechanical fasteners;
a left side panel portion having two or more left side panels, wherein neighboring left side panels are assembled with a plurality of first internal mechanical fasteners, a plurality of first external mechanical fasteners, and a plurality of second external mechanical fasteners;
a right side panel portion having two or more right side panels, wherein neighboring right side panels are assembled with a plurality of first internal mechanical fasteners, a plurality of first external mechanical fasteners, and a plurality of second external mechanical fasteners;
a front panel portion having a left front panel and a right front panel, wherein the left front panel and the right front panel are assembled with a plurality of second internal mechanical fasteners, a plurality of first external mechanical fasteners, and a plurality of second external mechanical fasteners; and
a ceiling panel portion having two or more ceiling panels, wherein neighboring ceiling panels are assembled with a plurality of first internal mechanical fasteners and a plurality of second external mechanical fasteners,
wherein the internal mechanical fasteners are installed between edges of the neighboring panels, wherein the first external mechanical fasteners are installed across border between inner surfaces of the neighboring panels, wherein the second external mechanical fasteners are installed across border between outer surfaces of the neighboring panels.

2. The sauna device of claim 1, wherein each of the first internal mechanical fasteners comprises a dowel and two holes provided through the edge of each of the right and left panels.

3. The sauna device of claim 1, wherein each of the second internal mechanical fasteners comprises an insert nut and a bolt.

4. The sauna device of claim 1, wherein each of the first external mechanical fasteners comprises two beams and two or more screws, wherein each of the two beams is installed along an edge on the outer surfaces of the right and left panels, wherein the each of the two or more screws is fastened through the two beams.

5. The sauna device of claim 1, wherein each of the second external mechanical fasteners comprises a buckle.

6. The sauna device of claim 1, further comprising a high bench heater provided at a corner defined by the bottom panel portion, the rear panel portion, and the left and right side panels.

7. The sauna device of claim 1, further comprising a low bench heater provided the high bench heater.

8. The sauna device of claim 1, wherein one of the left and right panels of the front panel portion comprises a door.

9. The sauna device of claim 1, wherein each of the first internal mechanical fasteners comprises a corner bracket, wherein the corner bracket is configured to align the neighboring panels.

10. The sauna device of claim 9, wherein the corner bracket comprises:
a male portion having two or more fastening holes and a protrusion; and
a female portion having two or more fastening holes and a locking hole,
wherein the male portion is attached to a first edge through the two or more fastening holes and the female portion is attached to a second edge through the two or more fastening holes,
wherein the male portion and the female portion are configured to be locked so as to align the neighboring panels.

11. The sauna device of claim 1, wherein each of the first external mechanical fasteners comprises a buckle.

12. The sauna device of claim 1, wherein each of the second external mechanical fasteners comprises two beams and two or more screws, wherein each of the two beams is installed along an edge on the outer surfaces of the right and left panels, wherein the each of the two or more screws is fastened through the two beams.
